(19) United States
(12) Patent Application Publication
(10) Pub. No.: US 2024/0070929 A1
(43) Pub. Date: Feb. 29, 2024

(54) AUGMENTED REALITY SYSTEM WITH TANGIBLE RECOGNIZABLE USER-CONFIGURED SUBSTRATES

(71) Applicant: Sony Interactive Entertainment LLC, San Mateo, CA (US)

(72) Inventors: Naoki Ogishita, San Mateo, CA (US); Daisuke Kawamura, San Mateo, CA (US); Udupi Ramanath Bhat, San Mateo, CA (US)

(21) Appl. No.: 17/821,773

(22) Filed: Aug. 23, 2022

(51) Int. Cl. G06T 11/00; G06V 20/20

(52) U.S. Cl. CPC G06T 11/00; G06V 20/20

(57) ABSTRACT

A tangible substrate such as paper is provided for an end user to configure into, e.g., stairs, a racetrack, etc. Machine vision processes images of the substrate to generate an electronic map. Using the map, images of virtual objects are generated and presented on an augmented reality (AR) display as moving over the substrate, which is visible through the display with the virtual objects appearing as being overlaid on the tangible substrate.

### FIELD

The present application relates generally to augmented reality (AR) systems with tangible recognizable user-configured substrates.

### BACKGROUND

Augmented reality (AR) devices mix images of virtual objects presented on a display with physical objects that can be see through the display, with the virtual objects appearing as if they are part of the physical world being seen through the display.

### SUMMARY

Present principles are directed to providing a more immersive AR system in which the end user(s) participate in creating the physical world that virtual objects must appear to interact with.

Accordingly, an assembly includes at least one tangible substrate configurable by a user and at least one processor configured with instructions to receive images of the tangible substrate. The processor is configured to, using the images of the tangible substrate, present, on at least one display through which the tangible substrate can be seen, an image of a virtual object moving over the tangible substrate.

The tangible substrate can include paper.

In example embodiments the instructions may be executable to produce a first visible effect on the virtual object for a first shape of the tangible substrate and to produce a second visible effect on the virtual object for a second shape of the tangible substrate. In some examples the first shape includes a rise, and the second shape includes a downhill. In other examples the first shape includes a horizontal plane, and the second shape includes a vertical plane.

In some implementations the instructions may be executable to produce a first visible effect on the virtual object for a first terrain type of the tangible substrate and to produce a second visible effect on the virtual object for a second terrain type of the tangible substrate. The terrain type may be indicated by, e.g., a user drawing and/or a tangible patch.

In example non-limiting embodiments, the instructions are executable to alter motion of the virtual object based at least in part on signals from at least one computer simulation controller. In some examples the instructions can be executable to alter motion of the virtual object based at least in part on at least one image of manual distortion of the tangible substrate.

In another aspect, a method incudes receiving images of a tangible substrate having contours, and presenting at least one virtual object on an augmented reality (AR) display through which the tangible substrate can be seen such that the virtual object appears to move against the virtual substrate conforming to a configuration of the virtual substrate.

In another aspect, a device includes at least one computer storage that is not a transitory signal and that in turn includes instructions executable by at least one processor to receive at least one image of at least one tangible substrate from at least one camera mounted on at least on augmented reality (AR) display through which the tangible substrate can be seen. The instructions are executable to, based at least in part on the image, generate for presentation on the AR display at least one virtual object moving as if conforming to the tangible substrate that is visible through the AR display.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a tangible substrate that has been cut into a strip and formed into a ramp;

FIG. 3 illustrates a tangible substrate that has been cut into a strip and formed into a racetrack;

FIG. 4 illustrates an AR display presenting a virtual object moving over the tangible substrate of FIG. 3;

FIG. 5 illustrates an AR display presenting virtual objects moving over a tangible substrate that has been formed into steps;

FIG. 6 schematically illustrates a virtual object in an AR system being automatically caused to move across a contoured tangible substrate;

FIG. 7 schematically adds to FIG. 6 a computer game controller manipulable by a user to control the virtual object;

FIG. 8 schematically adds to FIG. 6 images of a person manipulating the tangible substrate to alter motion of the virtual object;

FIG. 9 illustrates and example AR system consistent with present principles;

FIG. 10 illustrates a tangible substrate that has been cut into a strip and formed into a racetrack, along with user-drawn areas of differing terrain;

FIG. 11 illustrates yet another tangible substrate that has been formed by an end user into a desired shape with horizontal and vertical track portions;

FIG. 12 illustrates a tangible substrate that has been cut into a strip and formed into a racetrack, along with differing terrain patches provided in a kit;

FIG. 13 illustrates example logic in example flow chart format consistent with present principles; and

FIG. 14 illustrates an example mapping structure for terrain.

### DETAILED DESCRIPTION

This disclosure relates generally to computer ecosystems including aspects of consumer electronics (CE) device networks such as but not limited to computer game networks, including augmented reality (AR) networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

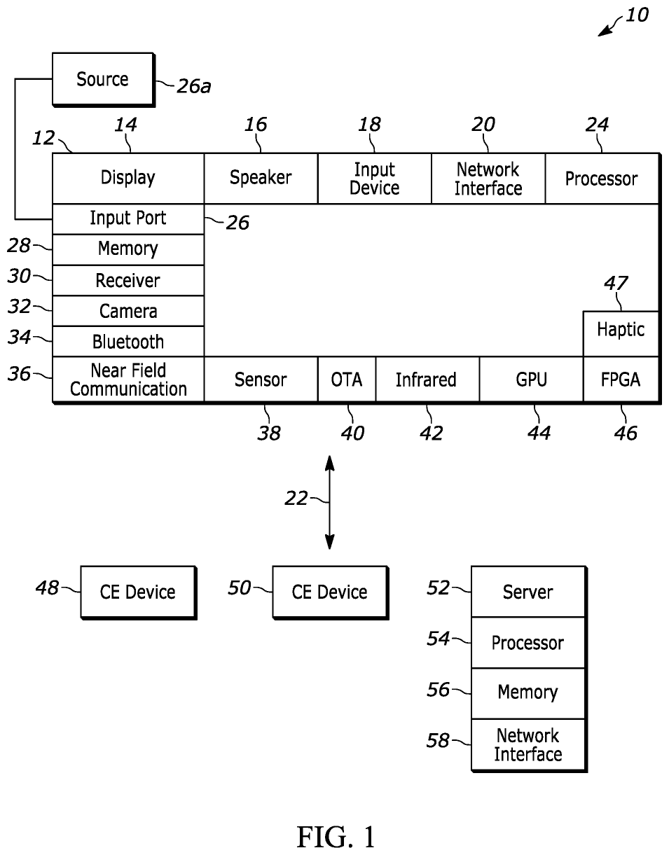

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptic/vibration generators 47 may be provided for generating tactile signals that can be sensed by a person holding or in contact with the device. The haptic generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

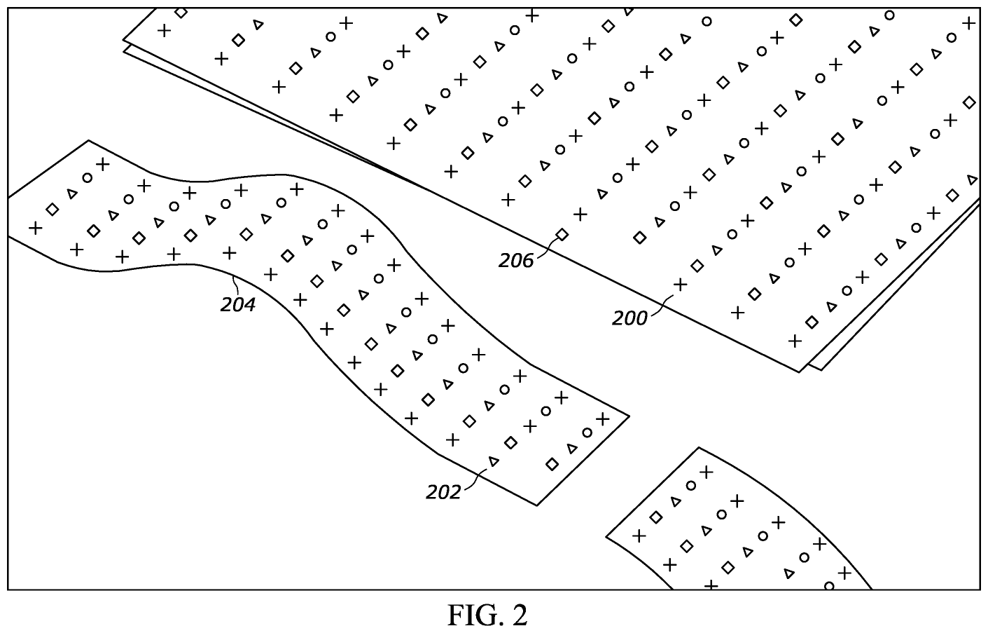

Now referring to FIG. 2, a tangible substrate 200, in the example shown, paper, has been cut into a strip 2-2 which a person has by hand formed into a ramp or mound 204. Visible indicia 206 may be printed on the substrat00 to aid in machine vision recognition of the shape and location of the substrate, although in some cases the indicia 206 may be omitted.

The indicia 206 may be, e.g., bar codes, quick response (QR) codes, or any pattern that may be recognized and the spacing between indicia elements known. In the example shown, the indicia 206 includes a pattern of X, 0, triangle, and square.

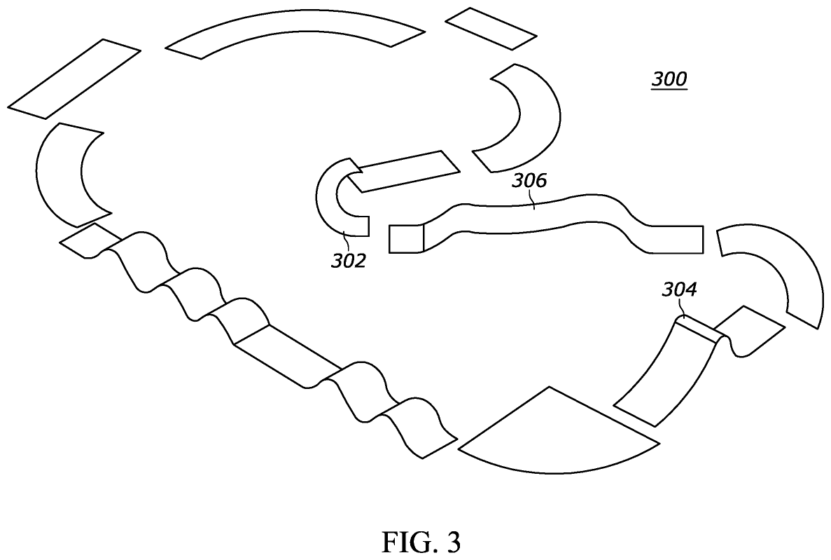

FIG. 3 illustrates a tangible substrate 300 that has been cut into multiple strips including a curve 302, a jump 304, and an elevated ramp 306 and formed into a racetrack.

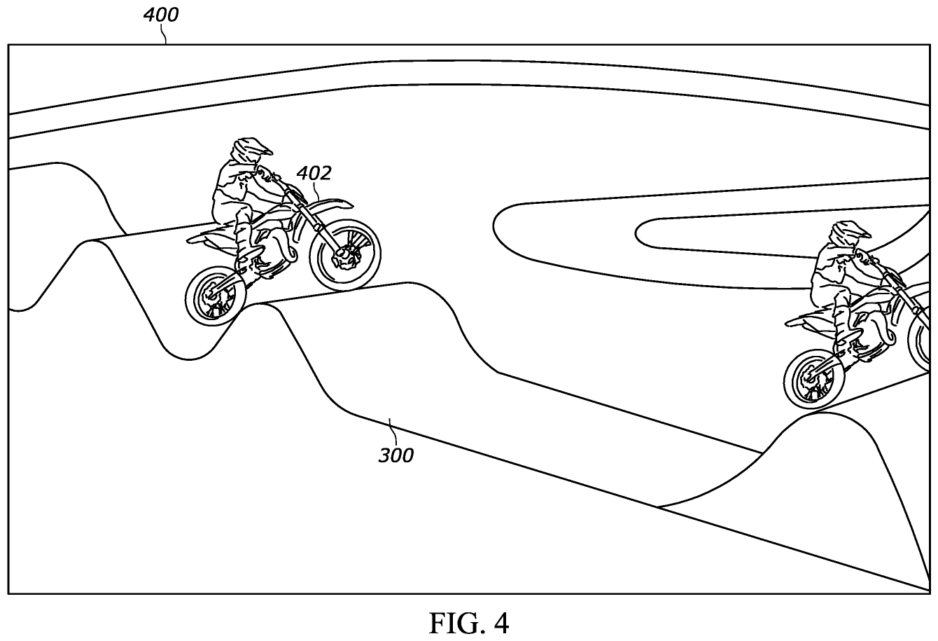

FIG. 4 illustrates an AR display 400 such as glasses, or as may be found on a tablet computer or cell phone, presenting a virtual object 402, in this case, a motorcycle with rider, moving over the tangible substrate 300 of FIG. 3, which is visible through the AR display 400.

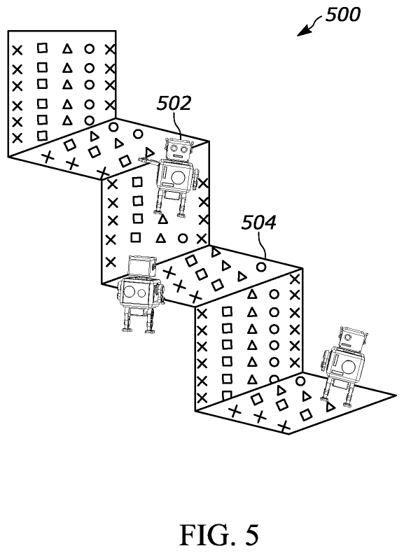

FIG. 5 illustrates an AR display 500 presenting virtual objects 502, in this case, bipedal figures jumping and climbing, moving over a tangible substrate 504 that has been formed into a series of horizontal steps separated by vertical walls, with the virtual objects climbing the steps. The substrate 504 is visible through the display 500.

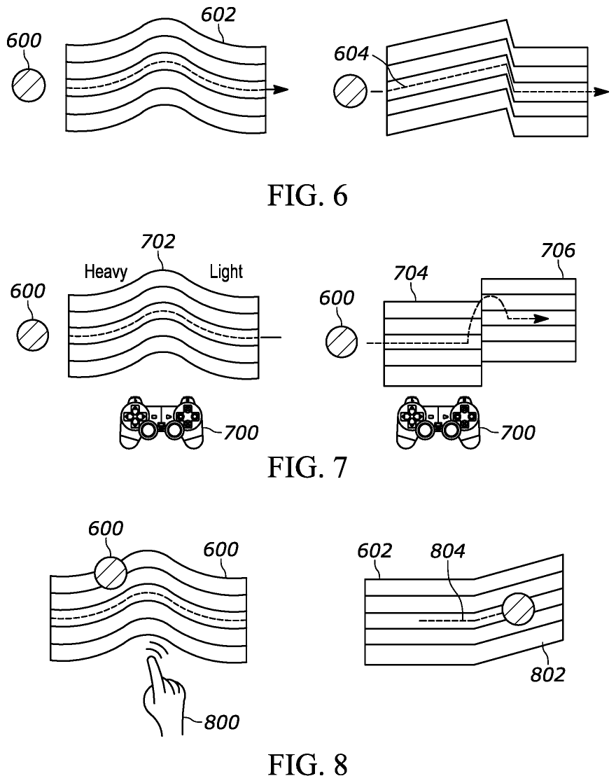

FIG. 6 schematically illustrates a virtual object 600, in this case, a ball, in an AR system being automatically caused to roll across a contoured tangible substrate 602 as indicated by the dashed line 604. In FIG. 6, based on images of the paper, the ball 600 is caused to rise over the hump 606 in the substrate 602 automatically.

FIG. 7 schematically adds to FIG. 6 a computer game controller 700 that is manipulable by a user to control the virtual object 600 as it rolls over the substrate 602. More specifically, on the left side of FIG. 7 the ball 600 rolls up and down a hump 702, and as it does so, the ball “feels” heavier going uphill and lighter going downhill. This may be achieved tactilely, e.g., by stiffening one or more control elements on the controller 700 when the ball is going uphill and loosening the control elements when the ball is rolling downhill, or it may be achieved visually, by slowing the ball down going uphill and speeding it up going downhill.

On the right side of FIG. 7 the ball 600 negotiates a jump from a lower step 704 of the substrate to a higher step 706. Tactile feedback of the jump can be implemented, for example, by loosening one or more control elements of the controller 700 while the ball is in the air jumping and then causing a haptic element in the controller 700 produce a single jolt or bump when the ball lands on the top step 706.

FIG. 8 schematically adds to FIG. 6 images of a person's hand 800 manipulating the tangible substrate to alter motion of the virtual object. On the left in FIG. 8 the person has pushed down onto the hump in the substrate 602 to cause the ball to hop in response to imaging the person-caused distortion in the tangible substrate. On the right in FIG. 8 the person has tilted up a portion 802 of the substrate 602, causing the ball to move down the tilted-up portion 802 as indicated by the arrow 804 in response to imaging the person-caused distortion in the tangible substrate.

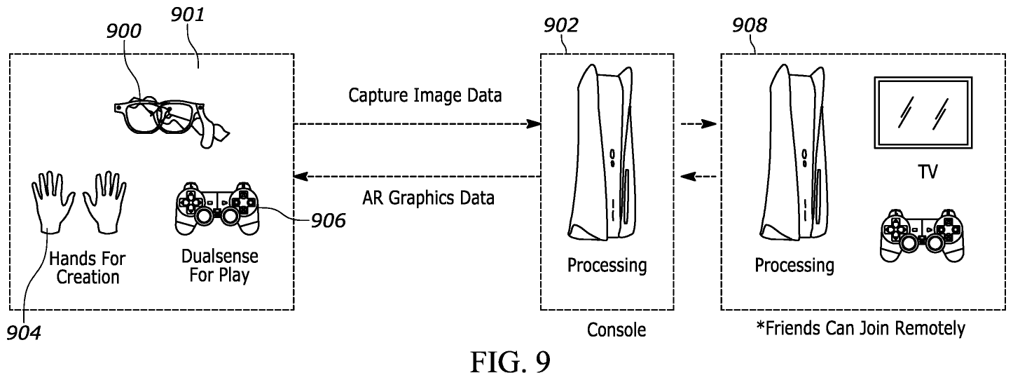

FIG. 9 illustrates and example AR system 900 that includes AR glasses 900 wirelessly sending images of a tangible substrate 901 taken by one or more cameras on the AR glasses 900 to a processor 902, in the example shown, implemented by a computer simulation console or other computing device. The processor 902 executes machine vision on the substrate images to in effect generate an electronic map of the substrate using, e.g., simultaneous localization and mapping (SLAM) techniques. The processor 902 also executes an AR engine, producing images of a virtual object moving through the electronic map and sending the images back as AR graphics data to the glasses 900. The AR graphics data is overlaid onto the real-world tangible substrate 901 as the user looks through the AR glasses to make it appear as if the virtual object is moving on the tangible substrate, conforming to its contours.

The user's hands 904 are also shown for configuring and manipulating the tangible substrate 901. Also, a computer simulation controller 906 is shown and can be manipulated to control motion of the virtual object. The processor 902 may also receive and return signals to one or more friend systems 908 for group play.

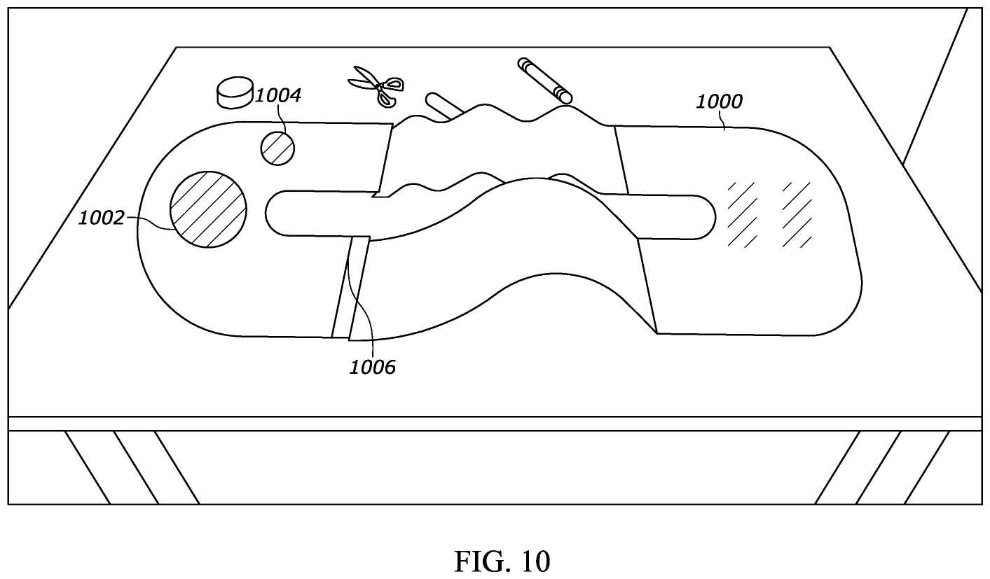

FIG. 10 illustrates a tangible substrate 1000 that has been cut into a strip and formed into a racetrack, along with user-drawn areas 1002, 1004 of differing terrain. For example, a brown area 1002 may indicate sand and a blue area 1004 may indicate water. Other features than color, such as shape, may be used to indicate a particular type of terrain. Other types of terrain may include a starting line 1006 for racing games in which virtual objects run laps over the substrate. The user may be prompted to draw a desired terrain and images of the drawing may be input to a ML model trained to recognize similar such drawings in the future as the desired terrain.

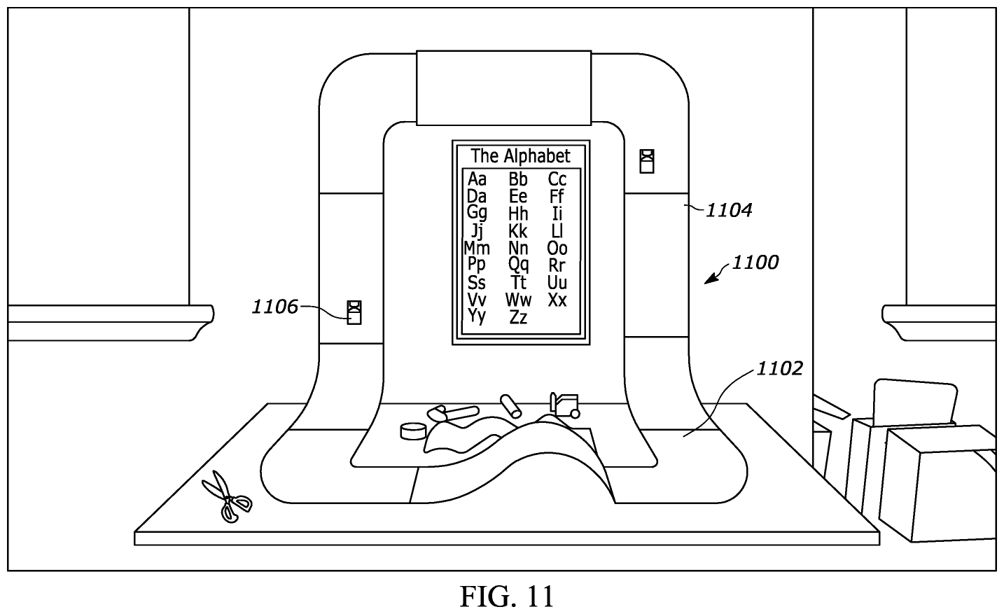

FIG. 11 illustrates yet another tangible substrate 1100 that has been formed by an end user into a desired shape with horizontal and vertical track portions 1102, 1104. The tangible substrate 1100 in FIG. 11 is depicted as seen through an AR display, so that virtual objects 1106 appear as if riding vertically up the vertical portion 1104.

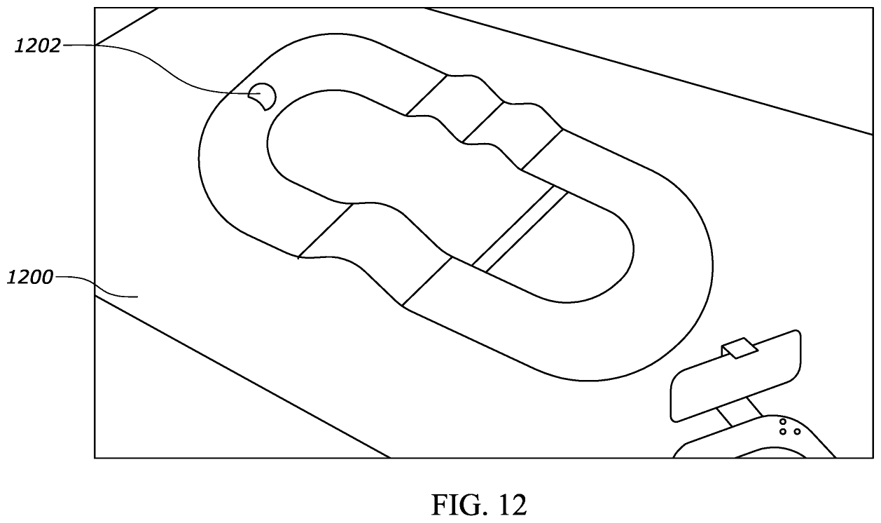

FIG. 12 illustrates a tangible substrate 1200 that has been cut into a strip and formed into a racetrack, along with differing terrain patches 1202 provided in a kit from a vendor. The terrain patches 1202 may be color-coded, shape-coded, or otherwise coded according to a coding scheme know to the AR processor for correlation of the patches to their respective terrain types.

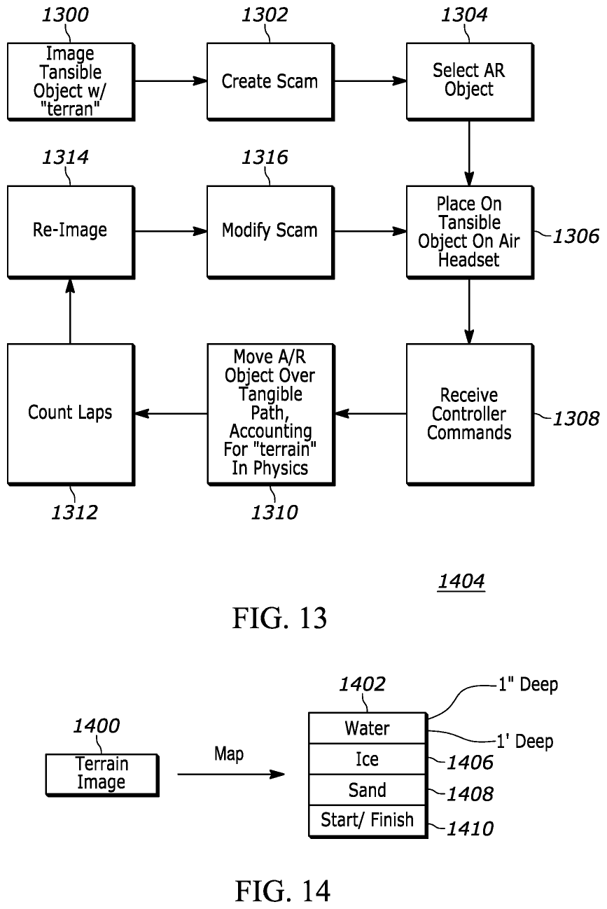

FIG. 13 illustrates example logic in example flow chart format consistent with present principles. Commencing at block 1300, the tangible substrate is imaged in real time, e.g., by one or more cameras on an AR headset such as glasses, along with indicators on the substrate of terrain, as drawn by an end user or as indicated by patches from a vendor.

Proceeding to block 1302, an electronic map of the substrate with terrain is created, e.g., using SLAM techniques. This is facilitated by imaging the substrate using cameras on AR glasses through which the user is looking at the substrate. The images of the substrate used to create the electronic map thus are of the substrate as seen by the user. Location and orientation signals from motions sensors in the AR glasses may be used to further refine the electronic map of the substrate to account for user motion.

One or more virtual objects are selected at block 1304 either automatically or in response to user input from, for instance, a computer game controller being operated to select an object from a list. Proceeding to block 1306, the selected object is presented on the display of the AR headset superimposed over the tangible substrate that can be seen through the display. This may be done by the processor by electronically placing and moving the virtual object in the electronic map that models the tangible substrate.

Block 1308 indicates that commands may be received from a computer simulation controller to control motion of the virtual object. The virtual object is moved at block 1310 over the tangible path of the substrate seen through the AR display behind the virtual object based on a physics engine that changes speed and behavior of the virtual object to account for rises and falls in the substrate and different terrain. For example, the physics engine may cause a virtual car to skid through water terrain, slide in icy terrain, and spin out in sandy terrain.

Block 1312 indicates that for the terrain 1006 in FIG. 10 for example (a starting line on a racetrack), the number of times a virtual object crosses the line may be counted to determine whether the race is completed, virtual object “speed”, etc. The tangible substrate can be re-imaged periodically in real time or in response to a trigger at block 1314, with the electronic map of the substrate being modified accordingly at block 1316 and the logic returning to block 1306.

FIG. 14 illustrates that an image 1400 of terrain on the tangible substrate may be recognized using machine vision and mapped to a particular terrain type 1402 in a list such as water, ice, sand, and the starting/finish line described above. In turn, each terrain type 1402 may be associated with various sub-types. In the case of water for example, the depth of the water may be a sub-type, with shallow water producing a first effect output by the physics engine (such as skidding) and deep water producing a second effect output by the physics engine (such as sinking).

While the particular embodiments are herein shown and described in detail, it is to be understood that the subject matter which is encompassed by the present invention is limited only by the claims.

What is claimed is:

1. An assembly, comprising:
at least one tangible substrate configurable by a user;
at least one processor configured with instructions to:
receive images of the tangible substrate;
using the images of the tangible substrate, present, on at least one display through which the tangible substrate can be seen, an image of a virtual object moving over the tangible substrate.

2. The assembly of claim 1, wherein the tangible substrate comprises paper.

3. The assembly of claim 1, wherein the instructions are executable to:
produce a first visible effect on the virtual object for a first shape of the tangible substrate and to produce a second visible effect on the virtual object for a second shape of the tangible substrate.

4. The assembly of claim 1, wherein the first shape comprises a rise and the second shape comprises a downhill.

5. The assembly of claim 1, wherein the first shape comprises a horizontal plane and the second shape comprises a vertical plane.

6. The assembly of claim 1, wherein the instructions are executable to:
produce a first visible effect on the virtual object for a first terrain type of the tangible substrate and to produce a second visible effect on the virtual object for a second terrain type of the tangible substrate.

7. The assembly of claim 6, wherein the terrain type is indicated by a user drawing.

8. The assembly of claim 6, wherein the terrain type is indicated by a tangible patch.

9. The assembly of claim 1, wherein the instructions are executable to:
alter motion of the virtual object based at least in part on signals from at least one computer simulation controller.

10. The assembly of claim 1, wherein the instructions are executable to:
alter motion of the virtual object based at least in part on at least one image of manual distortion of the tangible substrate.

11. A method comprising:
receiving images of a tangible substrate having contours;
presenting at least one virtual object on an augmented reality (AR) display through which the tangible substrate can be seen such that the virtual object appears to move against the virtual substrate conforming to a configuration of the virtual substrate.

12. The method of claim 11, wherein the tangible substrate comprises paper.

13. The method of claim 11, comprising producing a first visible effect on the virtual object for a first shape of the tangible substrate and producing a second visible effect on the virtual object for a second shape of the tangible substrate.

14. The method of claim 11, comprising producing a first visible effect on the virtual object for a first terrain type of the tangible substrate and producing a second visible effect on the virtual object for a second terrain type of the tangible substrate.

15. The method of claim 14, wherein the terrain type is indicated by a user drawing.

16. The method of claim 14, wherein the terrain type is indicated by a tangible patch.

17. The method of claim 11, comprising altering motion of the virtual object based at least in part on signals from at least one computer simulation controller.

18. The method of claim 11, comprising altering motion of the virtual object based at least in part on at least one image of manual distortion of the tangible substrate.

19. A device comprising:
at least one computer storage that is not a transitory signal and that comprises instructions executable by at least one processor to:
receive at least one image of at least one tangible substrate from at least one camera mounted on at least on augmented reality (AR) display through which the tangible substrate can be seen;
based at least in part on the image, generate for presentation on the AR display at least one virtual object moving as if conforming to the tangible substrate that is visible through the AR display.

20. The device of claim 19, wherein the tangible substrate comprises paper.
